(19) United States
(12) Patent Application Publication
(10) Pub. No.: US 2022/0070316 A1
(43) Pub. Date: Mar. 3, 2022

(54) DEVICE, INFORMATION PROCESSING SYSTEM, AND INFORMATION PROCESSING APPARATUS

(71) Applicant: Kohichiroh MINAMI, Kanagawa (JP)

(72) Inventor: Kohichiroh MINAMI, Kanagawa (JP)

(73) Assignee: Ricoh Company, Ltd.

(21) Appl. No.: 17/400,151

(22) Filed: Aug. 12, 2021

(30) Foreign Application Priority Data
Sep. 1, 2020 (JP) 2020-146618

(51) Int. Cl. H04N 1/00; H04N 1/44; G06F 16/903

(52) U.S. Cl. CPC H04N 1/00514; H04N 1/4433; H04N 2201/0094; H04N 1/00503; G06F 16/90335; H04N 1/00408

(57) ABSTRACT

A device includes circuitry. The circuitry receives a search request requesting searching for one or more setting items of the device, the search request being input by an authenticated user, the authenticated user being a user authenticated to use the device. The circuitry determines one or more particular setting items to be displayed on a display of the device from a search result obtained in response to the search request, based on authorization information of the authenticated user for the one or more setting items. The circuitry displays, on the display of the device, the particular one or more setting items determined to be displayed on the display of the device.

### CROSS-REFERENCE TO RELATED APPLICATIONS

This patent application is based on and claims priority pursuant to 35 U.S.C. § 119(a) to Japanese Patent Application No. 2020-146618, filed on Sep. 1, 2020, in the Japan Patent Office, the entire disclosure of which is hereby incorporated by reference herein.

### BACKGROUND

### Technical Field

Embodiments of the present disclosure relate to a device, an information processing system, and an information processing apparatus.

### Related Art

Some image forming apparatuses such as printers and multifunction peripherals have a search function of searching for a setting item.

The search function is a function of searching various setting items that the image forming apparatus includes. When a user or a service engineer wants to change a setting value of the image forming apparatus, the user or the service engineer operates the image forming apparatus to search for a setting item whose value is to be changed by using the search function.

A technique is known that determines presentation information items to be presented to a user and a presentation order of the presentation items from presentation information stored in a server apparatus storage device or a server apparatus in response to search input information input by the user and apparatus information obtained from an image forming apparatus, and presents the determined presentation information items in the determined presentation order.

### SUMMARY

An embodiment of the present disclosure includes a device including circuitry. The circuitry receives a search request requesting searching for one or more setting items of the device, the search request being input by an authenticated user, the authenticated user being a user authenticated to use the device. The circuitry determines one or more particular setting items to be displayed on a display of the device from a search result obtained in response to the search request, based on authorization information of the authenticated user for the one or more setting items. The circuitry displays, on the display of the device, the particular one or more setting items determined to be displayed on the display of the device.

Another embodiment of the present disclosure includes an information processing system including an information processing apparatus including first circuitry, and a device including second circuitry and being connected to the information processing apparatus through a network. The second circuitry of the device receives a search request requesting searching for one or more setting items of the device, the search request being input by an authenticated user, the authenticated user being a user authenticated to use the device. The second circuitry of the device transmits the search request to the information processing apparatus. The second circuitry of the device receives a search result corresponding to the search request from the information processing apparatus. The second circuitry of the device displays, on a display of the device, one or more particular setting items selected from the search result based on authorization information of the authenticated user for the one or more setting items. The first circuitry of the information processing apparatus receives, from the device, the search request requesting searching for the one or more setting items. The first circuitry of the information processing apparatus generates the search result in response to the search request. The first circuitry of the information processing apparatus transmits the search result to the device.

Another embodiment of the present disclosure includes an information processing apparatus connected to a device through a network, the information processing apparatus including circuitry. The circuitry receives, from the device, identification information of a user of the device and a search request requesting searching for one or more setting items. The circuitry generates a search result in response to the search request. The circuitry determines one or more particular setting items to be displayed on a display of the device from the search result, based on authorization information of the user for the one or more setting items, the authorization information being associated with the identification information. The circuitry transmits, to the device, the one or more particular setting items determined to be displayed on the display of the device.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a block diagram illustrating an example of a configuration of an information processing system, according to an embodiment of the present disclosure;

FIG. 2 is a diagram illustrating an example of a hardware configuration of an image forming apparatus, according to an embodiment of the present disclosure;

FIG. 3 is a diagram illustrating an example of a hardware configuration of a server, according to an embodiment of the present disclosure;

FIG. 4 is a block diagram illustrating an example of functional configurations of the image forming apparatus and the server, according to the first embodiment of the present disclosure;

FIG. 5 is a table illustrating an example of data structure of user authorization information stored in an authentication information storage unit, according to an embodiment of the present disclosure;

FIG. 6 is a table illustrating an example of data structure of subscribed application information stored in the authentication information storage unit, according to an embodiment of the present disclosure;

FIG. 7 is a table illustrating an example of data structure of authorization information of setting items stored in the authentication information storage unit, according to an embodiment of the present disclosure;

FIG. 8 is a flowchart illustrating an example of an operation of performing a search of a setting item, according to the first embodiment of the present disclosure;

FIG. 9 is a flowchart illustrating an example of an operation of determining one or more setting items for which a user has an authorization, according to the first embodiment of the present disclosure;

FIG. 10 is a diagram illustrating an example of a screen displayed on a display of the image forming apparatus before a search is performed, according to an embodiment of the present disclosure;

FIG. 11 is a diagram illustrating an example of a screen displayed on the display of the image forming apparatus after a search is performed (with authorization), according to an embodiment of the present disclosure;

FIG. 12 is a diagram illustrating an example of a screen displayed on the display of the image forming apparatus after a search is performed (without authorization), according to an embodiment of the present disclosure;

FIG. 13 is a block diagram illustrating an example of functional configurations of the image forming apparatus and the server, according to the second embodiment of the present disclosure; and

FIG. 14 is a flowchart illustrating an example of an operation of performing a search of a setting item, according to the second embodiment of the present disclosure.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

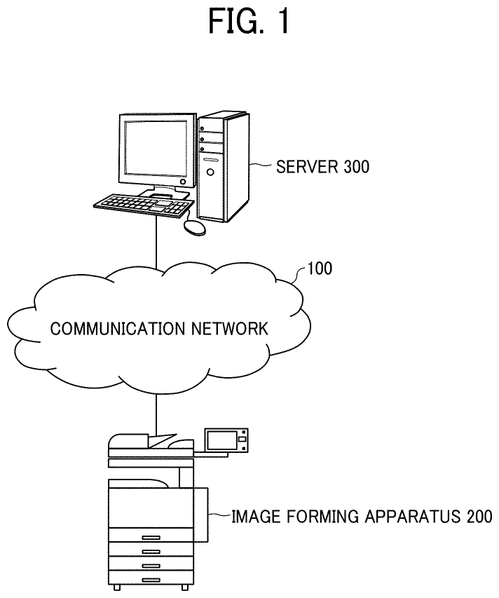

Embodiments of the present disclosure are described below with reference to the attached drawings. FIG. 1 is a block diagram illustrating an example of a configuration of an information processing system, according to an embodiment of the present disclosure. As illustrated in FIG. 1, the information processing system includes an image forming apparatus 200 and a server 300.

The image forming apparatus 200 is a multifunction peripheral having at least two functions of a copier function, a printer function, a scanner function, and a facsimile function. The image forming apparatus 200 is an example of a device in which a user searches for a desired setting item. The image forming apparatus 200 is communicable with the server 300 through a communication network 100, which is implemented by at least one of the Internet, a public network, and a dedicated network. The communication network 100 may include not only a wired network but also a wireless network.

The server 300 is a server apparatus that searches for a setting item in response to a search request transmitted from the image forming apparatus 200 and transmits a search result to the image forming apparatus 200 through the communication network 100.

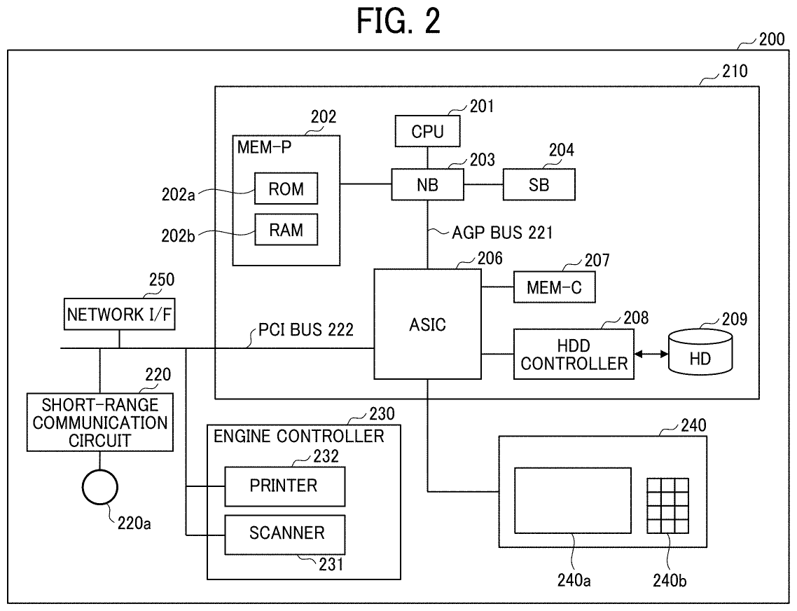

FIG. 2 illustrates a block diagram illustrating an example of a hardware configuration of the image forming apparatus 200, according to an embodiment of the present disclosure. As illustrated in FIG. 2, the image forming apparatus 200 includes a controller 210, a short-range communication circuit 220, an engine controller 230, a control panel 240, and a network interface (I/F) 250.

The controller 210 includes a central processing unit (CPU) 201 as a main processor of a computer, a system memory (MEM-P) 202, a north bridge (NB) 203, a south bridge (SB) 204, an application specific integrated circuit (ASIC) 206, a local memory (MEM-C) 207 as a storage unit, a hard disk drive (HDD) controller 208, and a hard disk (HD) 209 as a storage unit. The NB 203 and the ASIC 206 are connected through an accelerated graphics port (AGP) bus 221.

The CPU 201 is a controller that controls overall operation of the image forming apparatus 200. The NB 203 is a bridge that connects the CPU 201, to the MEM-P 202, the SB 204, and the AGP bus 221. The NB 203 includes a memory controller that controls reading and writing from and to the MEM-P 202, a peripheral component interconnect (PCI) master, and an AGP target.

The MEM-P 202 includes a read only memory (ROM) 202a as a memory that stores a program and data for implementing various functions of the controller 210. The MEM-P 202 further includes a random access memory (RAM) 202b as a memory that deploys the program and data, or as a drawing memory that stores drawing data for printing. The program stored in the ROM 202a may be stored in any computer-readable storage medium, such as a compact disc-read only memory (CD-ROM), compact disc-recordable (CD-R), or digital versatile disc (DVD), in a file format installable or executable by a computer, for distribution.

The SB 204 is a bridge that connects the NB 203 to a PCI device and a peripheral device. The ASIC 206 is an integrated circuit (IC) dedicated to an image processing use, and connects the AGP bus 221, the PCI bus 222, the HDD controller 208, and the MEM-C 207 to each other. The ASIC 206 includes a PCI target, an AGP master, an arbiter (ARB) as a central processor of the ASIC 206, a memory controller for controlling the MEM-C 207, a plurality of direct memory access controllers (DMACs) capable of converting coordinates of image data with a hardware logic, and a PCI unit that transfers data between a scanner 231 and a printer 232 through the PCI bus 222. A universal serial bus (USB) interface or an Institute of Electrical and Electronics Engineers 1394 (IEEE 1394) interface may be connected to the ASIC 206.

The MEM-C 207 is a local memory used as a buffer for image data to be copied or coding. The HD 209 stores various image data, font data for printing, and form data. The HDD controller 208 reads or writes various data from or to the HD 209 under control of the CPU 201. The AGP bus 221 is a bus interface for a graphics accelerator card, which has been proposed to accelerate graphics processing. Through directly accessing the MEM-P 202 by high-throughput, speed of the graphics accelerator card is improved.

The short-range communication circuit 220 includes a short-range communication antenna 220a. The short-range communication circuit 220 is a communication circuit that communicates in compliance with the near field communication (NFC) or the BLUETOOTH (registered trademark), for example.

The engine controller 230 includes the scanner 231 and the printer 232. The control panel 240 includes a panel display 240a and an operation panel 240b. The panel display 240a is, e.g., a touch panel that displays current settings or a selection screen and that receives a user input. The panel display 240a is an example of a display. The operation panel 240b includes a numeric keypad and a start key. The numeric keypad receives set values of various image forming parameters such as an image density parameter. The start key receives an instruction to start copying. The controller 210 controls overall operation of the image forming apparatus 200. For example, the controller 210 controls drawing, communication, or user inputs to the control panel 240. The scanner 231 and the printer 232 each performs various image processing, such as error diffusion or gamma conversion.

In response to an instruction to select a specific application through the control panel 240, for example, using a mode switch key, the image forming apparatus 200 selectively performs a document box function, a copier function, a printer function, and a facsimile function. In response to selection of the document box function, the image forming apparatus 200 operates in a document box mode to store document data. In response to selection of the copier function, the image forming apparatus 200 operates in a copier mode. In response to selection of the printer function, the image forming apparatus 200 operates in a printer mode. In response to selection of the facsimile function, the image forming apparatus 200 operates in a facsimile mode.

The network I/F 250 is an interface that enables the image forming apparatus 200 to perform data communication through the communication network 100. The short-range communication circuit 220 and the network I/F 250 are electrically connected to the ASIC 206 through the PCI bus 222.

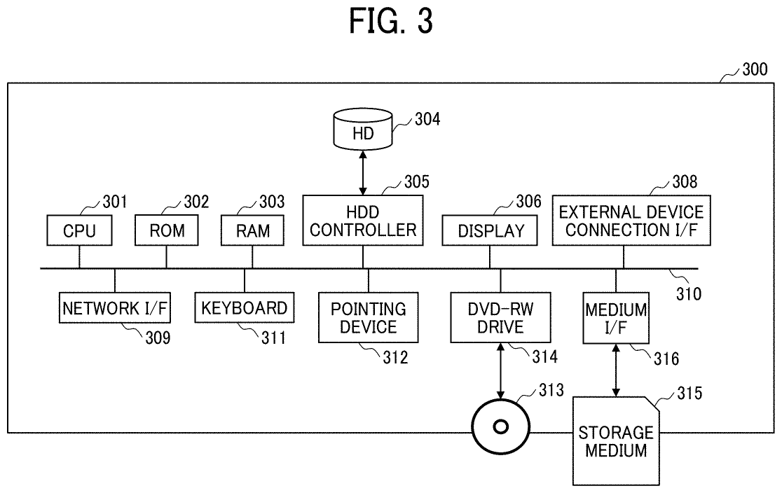

FIG. 3 is a diagram illustrating an example of a hardware configuration of the server 300, according to an embodiment of the present disclosure. As illustrated in FIG. 3, the server 300 is implemented by a computer. Specifically, the server includes a CPU 301, a ROM 302, a RAM 303, an HD 304, an HDD controller 305, a display 306, an external device connection I/F 308, a network I/F 309, a bus line 310, a keyboard 311, a pointing device 312, a digital versatile disk-rewritable (DVD-RW) drive 314, and a medium I/F 316. The CPU 301 controls overall operation of the server 300. The ROM 302 stores a control program such as an initial program loader (IPL) to boot the CPU 301. The RAM 303 is used as a work area for the CPU 301. The HD 304 stores various data such as a program. The HDD controller 305 controls reading and writing operation of various data from and to the HD 304 under control of the CPU 301. The display 306 displays various information such as a cursor, a menu, a window, a character, or an image. The external device connection I/F 308 is an interface that connects the server 300 to various external devices. Examples of the external devices include, but are not limited to, a universal serial bus (USB) memory and a printer. The network I/F 309 is an interface that enables the server 300 to perform data communication through the communication network 100. The bus line 310 is an address bus or a data bus, which electrically connects the hardware resources illustrated in FIG. 3 such as the CPU 301.

The keyboard 311 is an example of an input device provided with a plurality of keys for allowing a user to input characters, numerals, or various instructions. The pointing device 312 is an example of an input device that allows a user to select or execute a specific instruction, select a target for processing, or move a cursor being displayed. The DVD-RW drive 314 controls reading or writing of various data from or to a DVD-RW 313, which is an example of a removable storage medium. The removable storage medium is not limited to the DVD-RW and may be a digital versatile disc-recordable (DVD-R), for example. The medium I/F 316 reads or writes (stores) data from or to a storage medium 315 such as a flash memory.

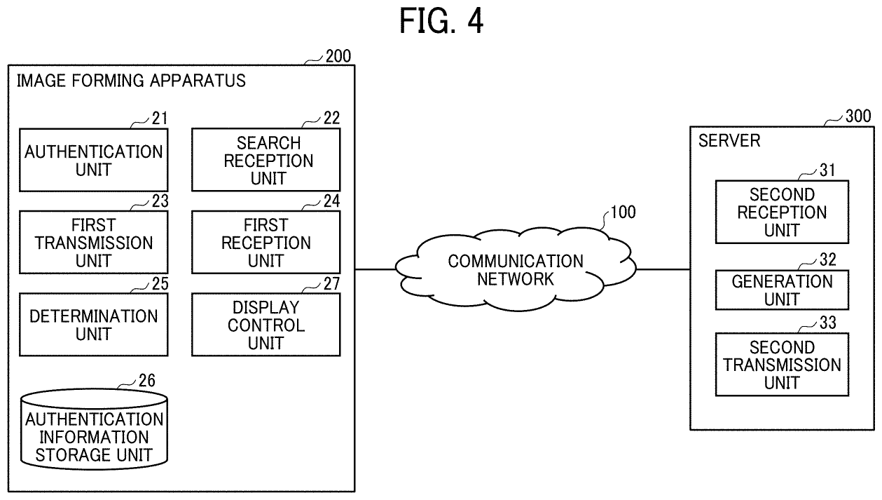

FIG. 4 is a block diagram illustrating an example of functional configurations of the image forming apparatus 200 and the server 300, according to the first embodiment of the present disclosure.

As illustrated in FIG. 4, the image forming apparatus 200 includes an authentication unit 21, a search reception unit 22, a first transmission unit 23, a first reception unit 24, a determination unit 25, a display control unit 27, and an authentication information storage unit 26. Each of these functional units is implemented by processes executed by the CPU 201 according to one or more programs installed on the image forming apparatus 200. The image forming apparatus 200 also uses the authentication information storage unit 26. The authentication information storage unit 26 is implemented, for example, by the HD 209 or a storage device connectable to the image forming apparatus 200 through a network.

The authentication unit 21 performs authentication for permitting a user who is to use the image forming apparatus 200 to use the image forming apparatus 200. In the authentication process, the user logs in to the image forming apparatus 200 as a general user or an administrator. Examples of the authentication include, but are not limited to, authentication using an integrated circuit (IC) card, short-range wireless communication, a QR code (registered trademark), and a combination of a login identifier (ID) and a password. In another example, if any suitable authentication system that can be used through the communication network 100 is provided, the image forming apparatus 200 uses such authentication system instead of the authentication unit 21. In still another example, the authentication does not necessarily to be performed, and the image forming apparatus 200 may be used without the authentication.

The search reception unit 22 receives a search term input by a user on an operation screen displayed on the control panel 940 of the image forming apparatus 200. Multiple search terms can be input.

In response to pressing a search start button on the operation screen displayed on the image forming apparatus 200, the first transmission unit 23 transmits the search term and a search request for requesting searching for setting items of various functions of the image forming apparatus 200 to the server 300. In another example, the search request is made while the user is inputting the search term, instead of in response to the pressing of the search start button.

The first reception unit 24 receives, from the server 300, a search result, which is a result of the search performed based on the search request transmitted by the first transmission unit 23. In the present disclosure, the first reception unit 24 receives, as the search result, a list of setting item IDs, each being unique to each setting item.

The determination unit 25 determines one or more setting items to be displayed on the operation screen of the image forming apparatus 200 based on authorization information and subscribed application information stored in the authentication information storage unit 26 and configuration information of the image forming apparatus 200 according to the search result received by the first reception unit 24. In the present disclosure, the configuration information refers to information that differs depending on a model or information that differs depending on a device. For example, the information that differs depending on the model includes information on a paper size that can be used in the image forming apparatus 200 (e.g., A3 size machine or A4 size machine), information on a color that can be used (e.g., a color machine or a monochrome machine), and other information that differs depending on the model (e.g., a wide machine or high-speed machine). The information that differs depending on the device refers to information that has a different configuration even for the same model, such as information on accessories (e.g., presence/absence of a facsimile or an extended network interface card (NIC)) or information on peripheral devices (e.g., a tray, a finisher, or a stapler).

The display control unit 27 displays, on the operation screen, the one or more setting items determined by the determination unit 25 to be displayed on the operation screen of the image forming apparatus 200. The described functional configuration enables a user using the image forming apparatus 200 to check the search result corresponding to the user's authorization on the panel display 240a, and to view and edit one or more setting items of the search result that does not include one or more setting items that the user is not permitted to view based on the user's authorization.

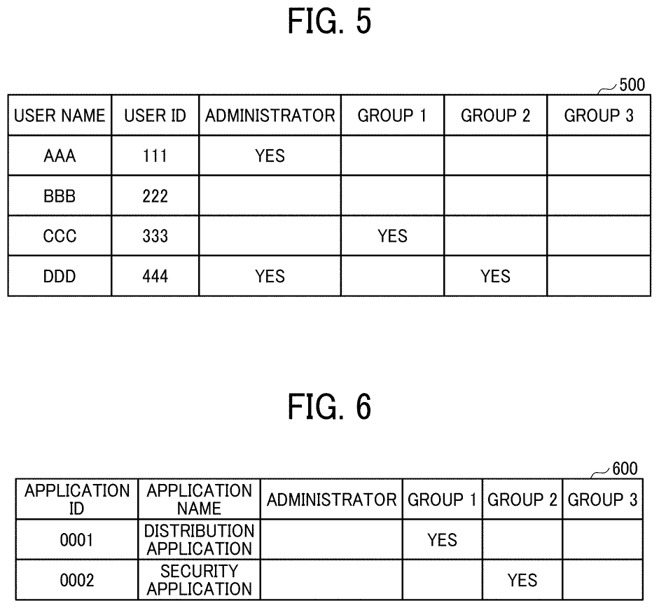

The authentication information storage unit 26 stores user authorization information, the subscribed application information, and authorization information of the setting items. Each of these information is described with reference to FIG. 5 to FIG. 7.

FIG. 5 is a table illustrating an example of data structure of the user authorization information stored in the authentication information storage unit 26. In the user authorization information illustrated in FIG. 5, authorization such as an administrator, a general user, and a group and a user ID are set for each user. The user ID is an ID unique to each user. The user ID is identification information for identifying a particular user. The user ID is an example of user identification information. In the example illustrated in FIG. 5, since the administrator authorization is set for a user “AAA”, the user “AAA” is permitted to view and edit a setting item that requires the administrator authorization. Since the administrator authorization is not set for a user “BBB,” the user “BBB” is treated as a general user. Since an authorization for Group 1 is set for a user “CCC”, the user “CCC” is permitted to view and edit a setting item that requires the authorization of Group 1. Since the administrator authorization and an authorization for Group 2 are set for a user “DDD”, the user “DDD” is permitted to view and edit both a setting item that requires the administrator authorization and a setting item that requires the authorization for Group 2.

FIG. 6 is a table illustrating an example of data structure of the subscribed application information stored in the authentication information storage unit 26. In the subscribed application information illustrated in FIG. 6, an application that can be used is set for each group. In the example illustrated in FIG. 6, a user to whom the authorization for Group 1 is set is permitted to use a distribution application, and a user to whom the authorization for Group 2 is set is permitted to use a security application. Although in the example illustrated in FIG. 6, the subscribed application is set for each group, in another example, the subscribed application is set for each user.

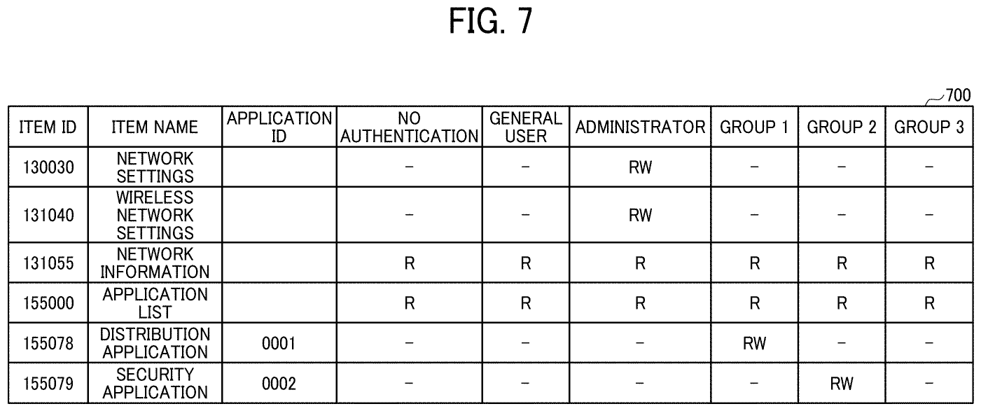

FIG. 7 is a table illustrating an example of data structure of the authorization information of setting items stored in the authentication information storage unit 26. An item ID is assigned to each of the setting items illustrated in FIG. 7, and permission or prohibition of viewing and editing is determined based on the authorization. Further, an application ID is assigned to a setting item related to a subscribed application, and permission or prohibition of viewing and editing is determined based on the subscribed application information. The application ID is not assigned to a setting item that is not related to a subscribed application. In the example illustrated in FIG. 7, the authorization information includes the general user, the administrator, Group 1, Group 2, and Group 3. If no authentication is performed, no authorization is assigned. In the table, “R” indicates a viewing authorization, “W” indicates an editing authorization, and “-” indicates no authorization. For example, with respect to a setting item whose item name is “network settings,” since “R” and “W” are set for the administrator, viewing and editing are permitted with the authorization information of the administrator, while viewing and editing are not permitted with other authorization information. Further, with respect to a setting item whose item name is “network information,” viewing is permitted with all the authorization information. However, since the setting item “network information” is a setting item that is not editable, the editing authorization is not set. Furthermore, with respect to the setting item whose item name “distribution application,” a user to whom the authorization information for Group 1 is set is permitted to view and edit the setting item.

As illustrated in FIG. 4, the server 300 includes a second reception unit 31, a generation unit 32, a second transmission unit 33. Each of these functional units is implemented by processes executed by the CPU 301 according to one or more programs installed on the server 300.

The second reception unit 31 receives the search term and the search request requesting searching for setting items of various functions of the image forming apparatus 200 transmitted from the image forming apparatus 200. The generation unit 32 searches for a setting item that matches the search term from information (e.g., a setting item name, term, screen layer, language) required for searching, the information being uploaded in advance to the server 300, and generates a list of setting item IDs.

The second transmission unit 33 transmits the list of setting item IDs generated by the generation unit 32 to the image forming apparatus 200.

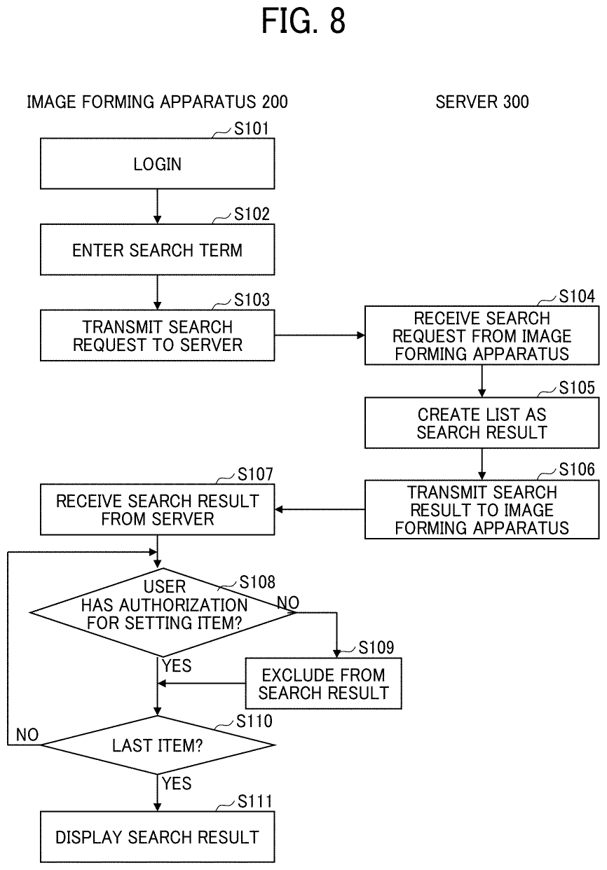

FIG. 8 is a flowchart illustrating an example of an operation of performing a search of a setting item performed by the information processing system, according to the first embodiment of the present disclosure.

First, the image forming apparatus 200 performs authentication in response to a user's login operation on the control panel 240 (S101), and acquires the authorization information of the user who performs the login operation (authenticated user). The image forming apparatus 200 receives an input of a search term for a setting item that the authenticated user is looking for (S102).

Next, the user who entered the search term presses a search start button displayed on the operation screen. In response to receiving the pressing of the search start button, the image forming apparatus 200 transmits a search request for a setting item based on the search term to the server 300 (S103).

In response to receiving the search request (S104), the server 300 generates a list of setting item IDs of setting items that match the search term from the information required for search uploaded in advance (S105). The server 300 transmits the generated list of setting item IDs to the image forming apparatus 200 as a search result in response to the search request (S106).

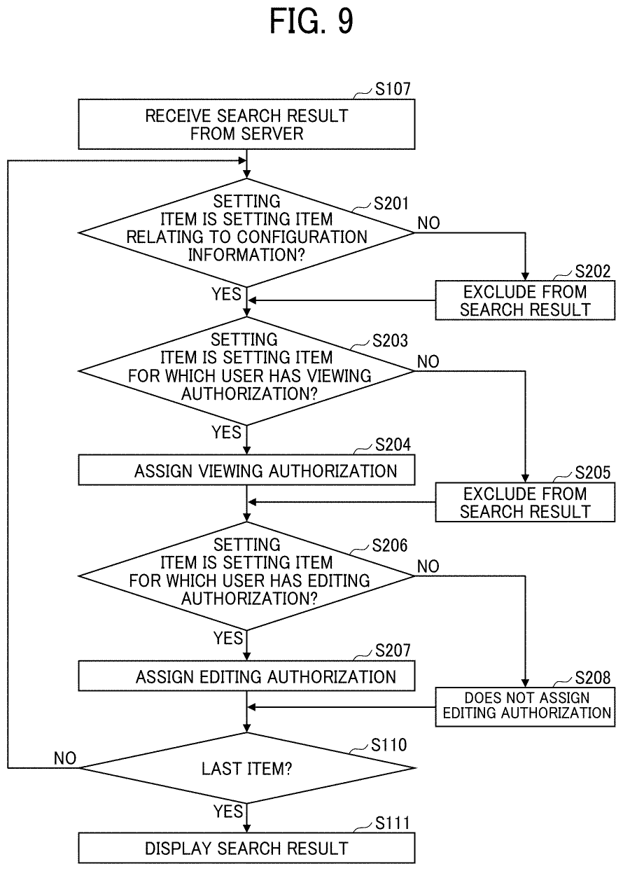

The image forming apparatus 200 receives the list of setting item IDs as the search result in response to the search request from the server 300 (S107). The server 300 determines, for each of the setting items associated with the received setting item IDs, whether the user who currently logs in the image forming apparatus 200 has authorization (S108). In the following description, the user who currently logs in the image forming apparatus 200 may be referred to as a “login user”. When the server 300 determines that the user does not have the authorization for a setting item as the determination target (No in S108), the server excludes the setting item ID of the setting item as the determination target from the list of setting item IDs. By contrast, when the server 300 determines that the user has the authorization for a setting item as the determination target (Yes in S108), the operation proceeds to S110 without the process of excluding the setting item ID of the setting item as the determination target from the list of setting item IDs. A detailed description is given below of the determination process with reference to FIG. 9.

After the determination process of the S108, the image forming apparatus 200 determines whether the determination of whether the user has an authorization is performed for all of the setting items (S110). When the image forming apparatus 200 determines that any setting item for which the determination process is not performed yet is still present, i.e., when the image forming apparatus determines that a setting item as the current determination target is not the last item (No in S110), the operation returns to S108, and the image forming apparatus performs the determination process for a setting item for which the determination process is not performed yet. When the image forming apparatus 200 determines that a setting item as the current determination target is the last item (Yes in S110), the operation proceeds to S111.

The image forming apparatus 200 displays one or more setting items for which the login user has authorization (S111). Thus, the image forming apparatus 200 displays one or more setting items for which the authenticated user has authorization among the setting items received as the search result from the server 300.

FIG. 9 is a flowchart illustrating an example of an operation of determining one or more setting items for which a user has an authorization, according to the first embodiment of the present disclosure.

In response to receiving the search result in S107 of FIG. 8, the determination unit 25 first acquires the configuration information of the image forming apparatus 200 and determines, for each of the setting items associated with the received setting item IDs, whether the setting item is a setting item related to the configuration information (S201). When the determination unit 25 determines that a setting item as the current determination target is a setting item that does not relate to the configuration information (No in S201), the determination unit 25 excludes the setting item from the search result (S202), and the operation proceeds to S203. For example, when a model of the image forming apparatus is a model in which a facsimile function is not installed, a setting item related to a facsimile is excluded from the search result. When the determination unit 25 determines that the setting item as the current determination target is a setting item related to the configuration information (Yes in S201), the operation proceeds to S203.

Next, the determination unit 25 determines, for each of the setting items associated with the received setting item IDs, whether the setting item is a setting item for which the user has a viewing authorization (S203). When the determination unit 25 determines that a setting item as the current determination target is a setting item for which the user has the viewing authorization (Yes in S203), the determination unit 25 assigns the viewing authorization to the setting item (S204), and the operation proceeds to S206. By contrast, when the determination unit 25 determines that a setting item as the current determination target is not a setting item for which the user has the viewing authorization (No in S203), the determination unit 25 excludes the setting item from the search result (S205), and the operation proceeds to S206.

Next, the determination unit 25 determines, for each of the setting items associated with the received setting item IDs, whether the setting item is a setting item for which the user has an editing authorization (S206). When the determination unit 25 determines that a setting item as the current determination target is a setting item for which the user has the editing authorization (Yes in S206), the determination unit 25 assigns the editing authorization to the setting item (S207), and the operation proceeds to S110. By contrast, when the determination unit 25 determines that a setting item as the current determination target is not a setting item for which the user has the editing authorization (No in S206), the determination unit 25 does not assign the editing authorization to the setting item (S208), and the operation proceeds to S110.

The image forming apparatus 200 performs the same or substantially the same processes of step S110 and subsequent steps as described with reference to FIG. 8. Thus, the image forming apparatus 200 displays one or more setting items that are permitted to be viewed to a user having the viewing authorization and displays one or more setting items that are permitted to viewed and edited to a user having the editing authorization.

Although the description given referring to FIG. 9 is of an example in which the determination unit 25 first determines whether the setting item is a setting item related to the configuration information, then determines whether the setting item is a setting item for which the user has the viewing authorization, and finally determines whether the setting item is a setting item for which the user has the editing authorization, in another example, the determination unit 25 performs these determination processes in an any suitable order. In still another example, the processes of S201 and S202 in FIG. 9 may be omitted.

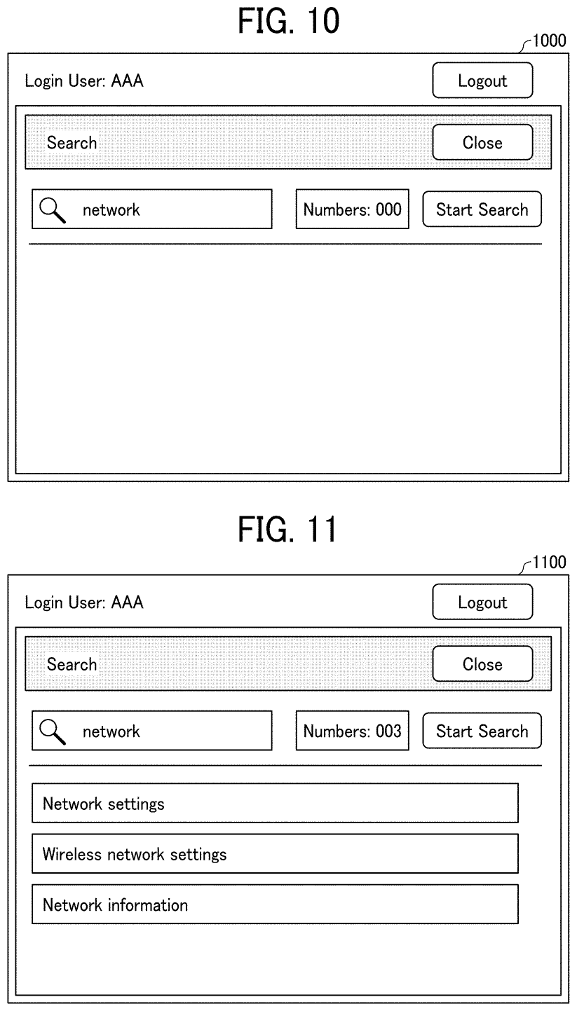

FIG. 10 is a diagram illustrating an example of an operation screen 1000 displayed on the panel display 240a of the image forming apparatus 200 before a search is performed.

In the example illustrated in FIG. 10, User AAA currently logs in to the image forming apparatus 200. In the example illustrated in FIG. 10, a search term is entered in a search term entry field displayed in the center of the operation screen 1000. FIG. 10 illustrates an example in which “network” is entered as the search term in the search term entry field. Since in the example of FIG. 10, a search is not performed yet, the number “000” is displayed in a “Numbers” field on the operation screen 1000. The user presses a search start button on the operation screen 1000 to instruct the image forming apparatus 200 to perform a search. When the user wants to end the search, the user presses a close button to return to a home screen.

FIG. 11 is a diagram illustrating an example of an operation screen 1100 displayed on the panel display 240a of the image forming apparatus 200 after the search is performed (with authorization). Specifically, FIG. 11 illustrates an example of the operation screen 1100 displayed when the login user is the administrator and the search is performed.

In the example illustrated in FIG. 11, three setting items are displayed as a search results under the search term entry field of the operation screen 1100. Since User AAA has the authorization for setting items “network setting,” “wireless setting,” and “network information,” the three setting items are displayed as a search result on the operation screen 1100. As a result of the search, in addition to the setting item name, a term used in the setting value, which is a lower layer of the setting item name, may be also displayed on the operation screen 1100. For example, in a case in which the term “network” is used in the setting item name, which is the upper layer, the setting item in which the network is used in the upper layer may be preferentially displayed, that is, in the upper area of the operation screen 1100. When the user presses any one of the setting item names displayed as the search result, the operation screen 1100 displayed on the image forming apparatus 200 transitions to a screen of the corresponding setting value. On the screen illustrated in FIG. 11, the user enters another search term in the search term entry field and presses the search start button to instruct the image forming apparatus 200 to perform a search.

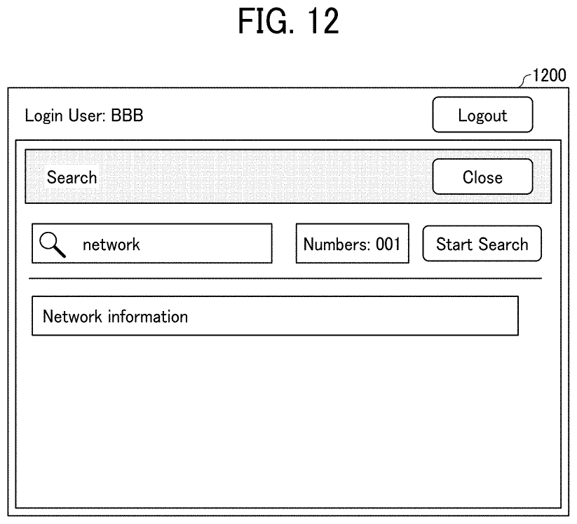

FIG. 12 is a diagram illustrating an example of an operation screen 1200 displayed on the panel display 240a of the image forming apparatus 200 after a search is performed (without authorization). Specifically, FIG. 12 illustrates an example of the operation screen 1200 displayed when the login user is the general user and a search is performed.

FIG. 12 illustrates an example in which User BBB logs in to the image forming apparatus 200, and the search is performed using the search term “network”, which is also used as the search term as in the example described with reference to FIG. 11. Compared with the operation screen 1100 illustrated in FIG. 11, in the example illustrated in FIG. 12, only the setting item “network information” is displayed on the operation screen 1200. In other words, the setting items of “network setting” and “wireless setting” are not displayed as the search result on the operation screen 1200 as compared with the case in which the login user is User AAA. The reason why the setting items of “network setting” and “wireless setting” are not displayed as the search result is that User BBB does not have the authorization for the setting items “network setting” and “wireless setting.”

As described, according to the first embodiment of the present disclosure, determination whether the authenticated user has an authorization for a setting item for which a search is performed is made based on the authentication information of the login user. In other words, according to the first embodiment of the present disclosure, one or more setting items to be displayed on the image forming apparatus 200 are determined from among setting items obtained by searching, based on the authorization information of the authenticated user. This enables the device (image forming apparatus 200) to display a result of search to a user having an authorization.

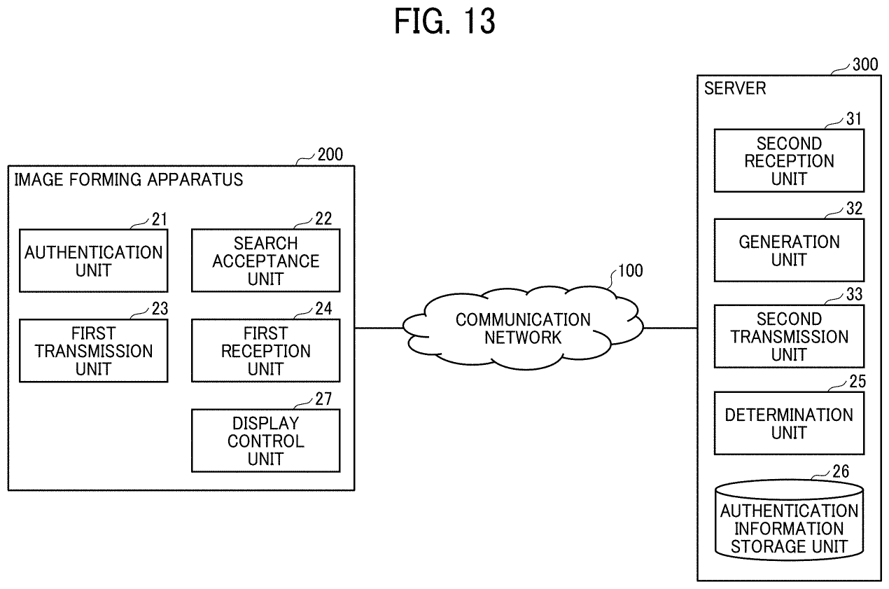

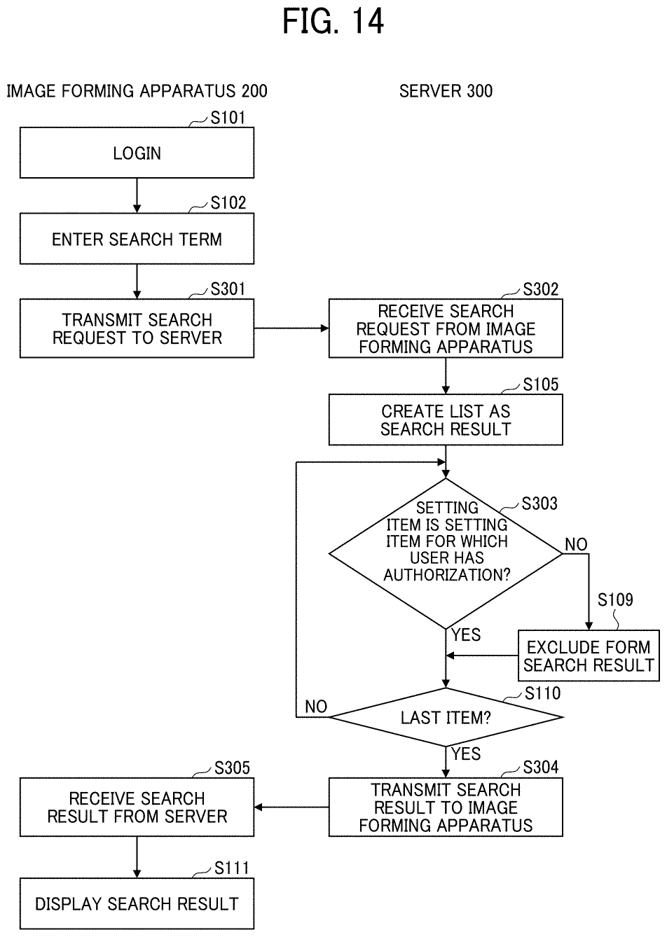

Referring now to FIG. 13 and FIG. 14, an information processing system is described according to a second embodiment. Description of the same hardware and functional configurations and operations as those of the first embodiment are omitted in the following description of the second embodiment, and differences from the first embodiment are described.

FIG. 13 is a block diagram illustrating an example of functional configurations of the image forming apparatus 200 and the server 300, according to the second embodiment of the present disclosure.

As illustrated in FIG. 13, in the second embodiment, the server 300 includes the determination unit 25 and the authentication information storage unit 26, which are included in the image forming apparatus 200 in the first embodiment.

FIG. 14 is a flowchart illustrating an example of an operation of performing a search of a setting item performed by the information processing system, according to the second embodiment of the present disclosure.

The processes of S101 and S102 are performed in the same or substantially the same manner as described with reference to FIG. 8 in the first embodiment.

In S301, in response to pressing the search start button on the operation screen, the image forming apparatus 200 transmits, to the server 300, the search request requesting searching for setting items of various functions of the image forming apparatus 200, the search term, the user ID who currently logs in the image forming apparatus 200, and the configuration information of the image forming apparatus 200.

In S302, the server 300 receives the search request requesting searching for setting items of various functions of the image forming apparatus 200 transmitted from the image forming apparatus 200 together with the search term and the user ID.

The process of S105 is performed in the same or substantially the same manner as described with reference to FIG. 8 in the first embodiment.

In S303, the server 300 acquires the authorization information corresponding to the received user ID from the authentication information storage unit 26, and determines, for each setting item, whether the login user has an authorization, based on the acquired authorization information.

The processes of S109 and S110 are performed in the same or substantially the same manner as described with reference to FIG. 8 in the first embodiment. In S304, the server 300 transmits, to the image forming apparatus 200, a list of setting item IDs for which the server 300 determines that the user who currently logs in the image forming apparatus 200 have the authorization.

In S305, the image forming apparatus 200 receives, from the server 300, the list of setting item IDs for which the user who currently logs in the image forming apparatus 200 have the authorization.

The process of S111 is performed in the same or substantially the same manner as described with reference to FIG. 8 in the first embodiment.

The detail of the determination process in S108 is the same or substantially the same as the process described with reference to FIG. 9 in the first embodiment.

Further, in another embodiment of the present disclosure, the image forming apparatus 200 may transmit the authorization information of the login user together with the search request to the server 300, and the server 300 may determine, for each setting item, whether the login user has an authorization.

As described, according to the second embodiment of the present disclosure, determination whether the authenticated user has an authorization for a setting item for which a search is performed is made based on the authentication information of the login user. In other words, according to the second embodiment of the present disclosure, one or more setting items to be displayed on the image forming apparatus 200 are determined from among setting items obtained by searching, based on the authorization information of the authenticated user. This enables the device (image forming apparatus 200) to display a result of search to a user having an authorization.

Further, since the user ID of the login user is transmitted to the server 300 together with the search request, the server 300 determines whether the user has the authorization. In other words, the server 300 determines the setting items to be displayed on the operation screen. This enables the device (image forming apparatus 200) to display a result of search to a user having an authorization and to reduce the processing load on the device (image forming apparatus 200).

In some cases, setting items of a device such as an image forming apparatus include setting items for which a particular user has an authorization such as a viewing authorization.

However, in the related art, since the search result is displayed for all users, even an unauthorized user can view the search result of the setting item.

According to one or more embodiments of the present disclosure, a search result based on a user's authorization information is displayed on a device.

The image forming apparatus 200 is merely one example of devices to which the embodiments are applicable. For example, the embodiment are applicable to an information processing apparatus such as an output device such as a projector (PJ), an interactive white board (a white board having an electronic whiteboard function capable of mutual communication (IWB)), and a digital signage, a head up display (HUD) device, and an industrial machine, an imaging device, a sound collecting device, a medical device, a networked home appliance, a laptop personal computer (PC), a mobile phone, a smartphone, a tablet terminal, a game console, a personal digital assistant (PDA), a digital camera, a wearable PC or a desktop PC.

Further, the embodiments are applicable to, instead of a single device, an information processing system including a plurality of devices and information processing apparatuses. In this case, the functional units illustrated in FIG. 4 may be distributed to a plurality of devices and information processing apparatuses. As still another embodiment, the image forming apparatus 200 and the server 300 may configured as a single entity, or at least one function of the server 300 may be provided in the image forming apparatus 200.

In one or more embodiments, the server 300 includes multiple computing devices, such as a server cluster. The multiple computing devices communicate with one another through any type of communication link including, for example, a network or a shared memory, and performs the operations described in the present disclosure. In substantially the same manner, for example, the image forming apparatus 200 includes such multiple computing devices configured to communicate with one another.

The server 300 performs cloud computing.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), a digital signal processor (DSP), a field programmable gate array (FPGA), and conventional circuit components arranged to perform the recited functions.

In the embodiments, the image forming apparatus 200 is an example of a device. The server 300 is an example of an information processing apparatus.

According to one or more embodiments, a program is provided that stores a plurality of instructions which causes a device to: receive a search request requesting searching for one or more setting items of the device, the search request being input by an authenticated user, the authenticated user being a user authenticated to use the device; determine one or more particular setting items to be displayed on a display of the device from a search result obtained in response to the search request, based on authorization information of the authenticated user for the one or more setting items; and displays, on the display of the device, the particular one or more setting items determined to be displayed on the display of the device.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

1. A device comprising circuitry configured to:
receive a search request requesting searching for one or more setting items of the device, the search request being input by an authenticated user, the authenticated user being a user authenticated to use the device;
determine one or more particular setting items to be displayed on a display of the device from a search result obtained in response to the search request, based on authorization information of the authenticated user for the one or more setting items; and
displays, on the display of the device, the particular one or more setting items determined to be displayed on the display of the device.

2. The device of claim 1, wherein
the circuitry determines the one or more particular setting items to be displayed on the display of the device from the search result based on the authorization information of the authenticated user and configuration information of the device.

3. The device of claim 1, wherein
the circuitry determines the one or more particular setting items to be displayed on the display of the device from the search result based on the authorization information of the authenticated user, configuration information of the device, and application information of an application that the authenticated user subscribes to.

4. The device of claim 1, wherein
the authorization information of the user includes information of an authorization to referring to the one or more setting items and information of an authorization to edit the one or more setting items.

5. The device of claim 1, wherein
the authorization information of the user includes information unique to the user and information of an authorization assigned to a group including the user.

6. An information processing system comprising:
an information processing apparatus including first circuitry; and
a device including second circuitry and being connected to the information processing apparatus through a network,
the second circuitry of the device being configured to
receive a search request requesting searching for one or more setting items of the device, the search request being input by an authenticated user, the authenticated user being a user authenticated to use the device,
transmit the search request to the information processing apparatus,
receive a search result corresponding to the search request from the information processing apparatus, and
display, on a display of the device, one or more particular setting items selected from the search result based on authorization information of the authenticated user for the one or more setting items,
the first circuitry of the information processing apparatus being configured to
receive, from the device, the search request requesting searching for the one or more setting items,
generate the search result in response to the search request, and
transmit the search result to the device.

7. An information processing apparatus connected to a device through a network, the information processing apparatus comprising circuitry configured to:
receive, from the device, identification information of a user of the device and a search request requesting searching for one or more setting items;
generate a search result in response to the search request;
determine one or more particular setting items to be displayed on a display of the device from the search result, based on authorization information of the user for the one or more setting items, the authorization information being associated with the identification information; and
transmit, to the device, the one or more particular setting items determined to be displayed on the display of the device.

8. The information processing apparatus of claim 7, wherein
the circuitry further receives configuration information of the device, and
the circuitry determines the one or more particular setting items to be displayed on the display of the device from the search result based on the authorization information of the user and the configuration information of the device.

9. The information processing apparatus of claim 8, wherein
the circuitry determines the one or more particular setting items to be displayed on the display of the device from the search result based on the authorization information of the user, the configuration information of the device, and application information of an application that the user subscribes to.
